(19) United States
(12) Patent Application Publication
(10) Pub. No.: US 2004/0230668 A1
(43) Pub. Date: Nov. 18, 2004

(54) Modular presentation device for use with PDA's and Smartphones

(76) Inventors: Jason Carnahan, Boise, ID (US); Paul Moreton, Plano, TX (US); Frank Ahern, Scottsdale, AZ (US); Desi Rhoden, Austin, TX (US); Jeff Doss, Phoenix, AZ (US); Charles Mollo, Phoenix, AZ (US)

Correspondence Address: Robert C. Klinger, Jackson Walker LLP., Suite 600, 2435 North Central Expressway, Richardson, TX, 75080, US

(21) Appl. No.: 10/766,660

(22) Filed: Jan. 28, 2004

Related U.S. Application Data
(63) Continuation-in-part of application No. 09/559,678, filed on Apr. 27, 2000.
(63) Continuation-in-part of application No. 09/819,054, filed on May 20, 2000, now Pat. No. 6,715,022.
Application No. 09/819,054 is a division of application No. 09/130,058, filed on Aug. 6, 1998, now Pat. No. 6,070,214.
(60) Provisional application No. 60/532,300, filed on Dec. 23, 2003.
(60) Provisional application No. 60/198,317, filed on Apr. 19, 2000.

(51) Int. Cl. G06F 15/16

(52) U.S. Cl. 709/217

(57) ABSTRACT

A modular computer system (20) including a universal connectivity station (UCS) (22) having a processor (42) interconnecting a plurality of physically remote modules including a PDA (36) and Smartphone (38), and a display (34). Each module of the modular computer system (20) appear to each device to be interconnected to the other. The UCS (22) enables the PDA (36) and Smartphone (38) to drive the display (38). External control devices including a keyboard (50) and mouse (52) may also control the UCS (22). The UCS (22) may translate the keyboard inputs to keystrokes, and mouse movements clicks to cursor movements and stylus taps for visually rendering on the PDA and Smartphone.

### CROSS REFERENCE TO RELATED APPLICATIONS

This application is a Continuation-in-Part (CIP) of U.S. patent application Ser. No. 09/559,678, entitled “Modular Computer System”, filed on Apr. 27, 2000, which claims priority of provisional patent application Ser. No. 60/198,317 entitled “Split-Bridge Systems, Applications and Methods of Use” filed on Apr. 19, 2000, and is also a CIP of U.S. patent application Ser. No. 09/819,054, entitled “Unique Serial Protocol Mimicking Parallel Bus” filed on May 20, 2000, which is a Divisional of U.S. patent application Ser. No. 09/130,058, entitled “Serially Linked Bus Bridge for Expanding Access Over a First Bus to a Second Bus” filed on Aug. 6, 1998, now issued as U.S. Pat. No. 6,070,214, the teachings of each incorporated herein by reference.

### CLAIM OF PRIORITY

This application claims priority of U.S. Provisional application Ser. No. 60/532,300 filed Dec. 23, 2003 entitled “Handheld System and Method” the teachings of which are incorporated herein by reference.

### FIELD OF THE INVENTION

The present invention is generally related to computers and data processing systems, and more particularly to computer systems having at least one host processor and connectable to a plurality of peripherals, expansion devices, and/or other computers, including notebook and other portable and handheld computers, storage devices, displays, USB, IEEE 1394, audio, keyboards, mouse's and so forth.

### BACKGROUND OF THE INVENTION

Computer systems today are powerful, but are rendered limited in their ability to be divided into modular components due to a variety of technical limitations of today's PCI bus technology. And in their ability to adapt to changing computing environments. The PCI bus is pervasive in the industry, but as a parallel data bus is not easily extended over any distance or bridged to other remote PCI based devices due to loading and physical constraints, most notably the inability to extend the PCI bus more than a few inches. Full bridges are known, such as used in traditional laptop computer/docking stations. However, separating the laptop computer from the docking station a significant distance has not been possible. Moreover, the processing power of computer systems has been resident within the traditional computer used by the user because the microprocessor traditionally is directly connected to and resident on the PCI motherboard. Thus, upgrading processing power usually meant significant costs and/or replacing the computer or computer system.

PCI

The PCI bus is primarily a wide multiplexed address and data bus that provides support for everything from a single data word for every address to very long bursts of data words for a single address, with the implication being that burst data is intended for sequential addresses. Clearly the highest performance of the PCI bus comes from the bursts of data, however most PCI devices require reasonable performance for even the smallest single data word operations. Many PCI devices utilize only the single data mode for their transfers. In addition, starting with the implementation of the PCI 2.1 version of the specification, there has been at least pseudo isochronous behavior demanded from the bus placing limits on an individual device's utilization of the bus, thus virtually guaranteeing every device gets a dedicated segment of time on a very regular interval and within a relatively short time period. The fundamental reason behind such operation of the PCI bus is to enable such things as real time audio and video data streams to be mixed with other operations on the bus without introducing major conflicts or interruption of data output. Imagine spoken words being broken into small unconnected pieces and you get the picture. Prior to PCI 2.1 these artifacts could and did occur because devices could get on the bus and hold it for indefinite periods of time. Before modification of the spec for version 2.1, there really was no way to guarantee performance of devices on the bus, or to guarantee time slot intervals when devices would get on the bus. Purists may argue that PCI is still theoretically not an isochronous bus, but as in most things in PC engineering, it is close enough.

Traditional High Speed Serial

Typical high speed serial bus operation on the other hand allows the possibility of all sizes of data transfers across the bus like PCI, but it certainly favors the very long bursts of data unlike PCI. The typical operation of a serial bus includes an extensive header of information for every data transaction on the bus much like Ethernet, which requires on the order of 68 bytes of header of information for every data transaction regardless of length. In other words, every data transaction on Ethernet would have to include 68 bytes of data along with the header information just to approach 50% utilization of the bus. As it turns out Ethernet also requires some guaranteed dead time between operations to “mostly” prevent collisions from other Ethernet devices on the widely disperse bus, and that dead time further reduces the average performance.

The typical protocol for a serial bus is much the same as Ethernet with often much longer header information. Virtually all existing serial bus protocol implementations are very general and every block of data comes with everything needed to completely identify it. FiberChannel (FC) has such a robust protocol that virtually all other serial protocols can be transmitted across FC completely embedded within the FC protocol, sort of like including the complete family history along with object size, physical location within the room, room measurements, room number, street address, city, zip code, country, planet, galaxy, universe, . . . etc. and of course all the same information about the destination location as well, even if all you want to do is move the object to the other side of the same room. Small transfers across many of these protocols, while possible, are extremely expensive from a bandwidth point of view and impractical in a bus applications where small transfers are common and would be disproportionally burdened with more high overhead than actual data transfer. Of course the possibility of isochronous operation on the more general serial bus is not very reasonable.

Recreating High Speed Serial For PCI

In creating the proprietary Split-Bridge™ technology, Mobility electronics of Phoenix Ariz., the present applicant, actually had to go back to the drawing board and design a far simpler serial protocol to allow a marriage to the PCI bus, because none of the existing implementations could coexist without substantial loss of performance. For a detailed discussion of Applicant's proprietary Split-Bridge™ technology, cross reference is made to Applicant's co-pending commonly assigned patent applications identified as Ser. No. 09/130,057 and 09/130,058 both filed Jun. 6, 1998, the teachings of each incorporated herein by reference. The Split-Bridge™ technology approach is essentially custom fit for PCI and very extensible to all the other peripheral bus protocols under discussion like PCIx, and LDT™ set forth by AMD Corporation. LDT requires a clock link in addition to its data links, and is intended primarily as a motherboard application, wherein Split-Bridge™ technology is primarily intended to enable remote bus recreation. As the speeds of motherboard buses continue to grow faster, Split-Bridge™ can be readily adapted to support these by increasing the serial bus speed and adding multiple pipes. Split-Bridge™ technology fundamentals are a natural for extending anything that exists within a computer. It basically uses a single-byte of overhead for 32 bits of data and address—actually less when you consider that byte enables, which are not really “overhead”, are included as well.

Armed with the far simpler protocol, all of the attributes of the PCI bus are preserved and made transparent across a high speed serial link at much higher effective bandwidth than any existing serial protocol. The net result is the liberation of a widely used general purpose bus, and the new found ability to separate what were previously considered fundamental inseparable parts of a computer into separate locations. When the most technical reviewers grasp the magnitude of the invention, then the wheels start to turn and the discussions that follow open up a new wealth of opportunities. It now becomes reasonable to explore some of the old fundamentals, like peer-to-peer communication between computers that has been part of the basic PCI specification from the beginning, but never really feasible because of the physical limits of the bus prior to Split-Bridge™ technology. The simplified single-byte overhead also enables very efficient high speed communication between two computers and could easily be extended beyond PCI.

The proprietary Split-Bridge™ technology is clearly not “just another high speed link” and distinguishing features that make it different represent novel approaches to solving some long troublesome system architecture issues.

First of all is the splitting of a PCI bridge into two separate and distinct pieces. Conceptually, a PCI bridge was never intended to be resident in two separate modules or chips and no mechanism existed to allow the sharing of setup information across two separate and distinct devices. A PCI bridge requires a number of programmable registers that supply information to both ports of a typical device. For the purpose of the following discussion, the two ports are defined into a north and south segment of the complete bridge.

The north segment is typically the configuration port of choice and the south side merely takes the information from the registers on the north side and operates accordingly. The problem exists when the north and south portions are physically and spatially separated and none of the register information is available to the south side because all the registers are in the north chip. A typical system solution conceived by the applicant prior to the invention of Split-Bridge™ technology would have been to merely create a separate set of registers in the south chip for configuration of that port. However, merely creating a separate set of registers in the south port would still leave the set up of those registers to the initialization code of the operating system and hence would have required a change to the system software.

Split-Bridge™ technology, on the other hand, chose to make the physical splitting of the bridge into two separate and spaced devices “transparent” to the system software (in other words, no knowledge to the system software that two devices were in fact behaving as one bridge chip). In order to make the operations transparent, all accesses to the configuration space were encoded, serialized, and “echoed” across the serial link to a second set of relevant registers in the south side. Such transparent echo between halves of a PCI bridge or any other bus bridge is an innovation that significantly enhances the operation of the technology.

Secondly, the actual protocol in the Split-Bridge™ technology is quite unique and different from the typical state of the art for serial bus operations. Typically transfers are “packetized” into block transfers of variable length. The problem as it relates to PCI is that the complete length of a given transfer must be known before a transfer can start so the proper packet header may be sent.

Earlier attempts to accomplish anything similar to Split-Bridge™ technology failed because the PCI bus does not inherently know from one transaction to the next when, or if, a transfer will end or how long a block or burst of information will take. In essence the protocol for the parallel PCI bus (and all other parallel, and or real time busses for that matter) is incompatible with existing protocols for serial buses.

An innovative solution to the problem was to invent a protocol for the serial bus that more or less mimics the protocol on the PCI. With such an invention it is now possible to substantially improve the performance and real time operation here to for not possible with any existing serial bus protocol.

The 8 bit to 10 bit encoding of the data on the bus is not new, but follows existing published works. However, the direct sending of 32 bits of information along with the 4 bits of control or byte enables, along with an additional 4 bits of extension represents a 40 bit for every 36 bits of existing PCI data, address, and control or a flat 10% overhead regardless of the transfer size or duration, and this approach is new and revolutionary. Extending the 4 bit extension to 12 or more bits and including other functionality such as error correction or retransmit functionality is also within the scope of the Split-Bridge™ technology.

New Applications of the Split-Bridge™ Technology

Basic Split-Bridge™ technology was created for the purpose of allowing a low cost, high speed serial data communications between a parallel system bus and remote devices. By taking advantage of the standard and pervasive nature of the PCI bus in many other applications in computing, dramatic improvements in the price performance for other machines is realized. The present invention comprises a revolutionary application rendered possible due to the attributes of applicant's proprietary Split-Bridge™ technology.

### SUMMARY OF THE INVENTION

The present invention achieves technical advantages as a modular system having a universal connectivity station adapted to interconnect a plurality of physically separated devices, including PDA's and Smartphones, and a display. Serial links extending therebetween may be wireless or wireline, and may employ proprietary Split-Bridge™ technology of applicant.

The present invention derives technical advantages as a modular computing system interconnecting two or more spatially separate and distinct devices via a universal connectivity station (UCS). The core is the performance module of the modular computing system and may include some or all of the central processing unit (CPU), memory, AGP Graphics, and System Bus Chip adapted to communicably couple these together or in combination with other items. The UCS communicably couples the processor module via high speed serial links to other individual modules, such as storage modules including hard disk drives, a user interface module consisting of a keyboard, mouse, monitor and printer, as well as a LAN Module such as any Internet connection or another UCS, another UCS, audiovisual device, LAN storage just to name a few.

The modular computer system of the present invention including the UCS is a novel approach to computer architecture and upgrade ability. Advantageously, the separate performance module may be selectively upgraded or modified as desired and as technology increases the performance of key components including microprocessor speed, standards, and architectures without necessitating the replacement or modification of the rest of the computer system. The UCS allows the performance module to be upgraded while the rest of the system devices coupled thereto does not need to be modified. Upgrading to single or multiple processors in the performance module or modules is readily possible. Whole organizations can standardize to a single UCS regardless of the type of performance or portability required by the users, thus addressing for the first time the means of systems level support. In security sensitivity environments, it is possible to separate the “stored media” or computer central processor, or any other component of the system and connectivity from the operators, and still maintain the speed element so important in today's businesses.

### BRIEF DESCRIPTION OF THE DRAWINGS

FIG. 1 illustrates prior art computer systems depicted as a traditional performance desk top computer shown at 10, and a portable computing device 12, such as a notebook or laptop computer, mechanically coupled to mechanical docking station 14;

FIG. 2 is a block diagram of a prior art bridge 16 used to couple two system computing buses, such as used between the portable computing device 12 and the mechanical docking station 14 shown in FIG. 1;

FIG. 3 illustrates the proprietary Split-Bridge™ technology serial communication technology of the applicant enabling high speed serial communications within the modular computer system of the present invention;

FIG. 4 is a block diagram of the modular computer system of the present invention utilizing a universal connectivity station (UCS) communicably coupled to a plurality of devices via serial links, such as the Split-Bridge™ technology serial links employed using fixed wire, optical, or wireless communication links;

FIG. 5 is a screenshot of a PC Utility for converting a Powerpoint® file into a format executable on a PDA/Smartphone;

FIG. 6 is a screenshot of a PDA/Smartphone executing a visual presentation program to be displayed on a physically remote display via the UCS; and

FIG. 7 is a screenshot of the PDA/Smartphone background thread.

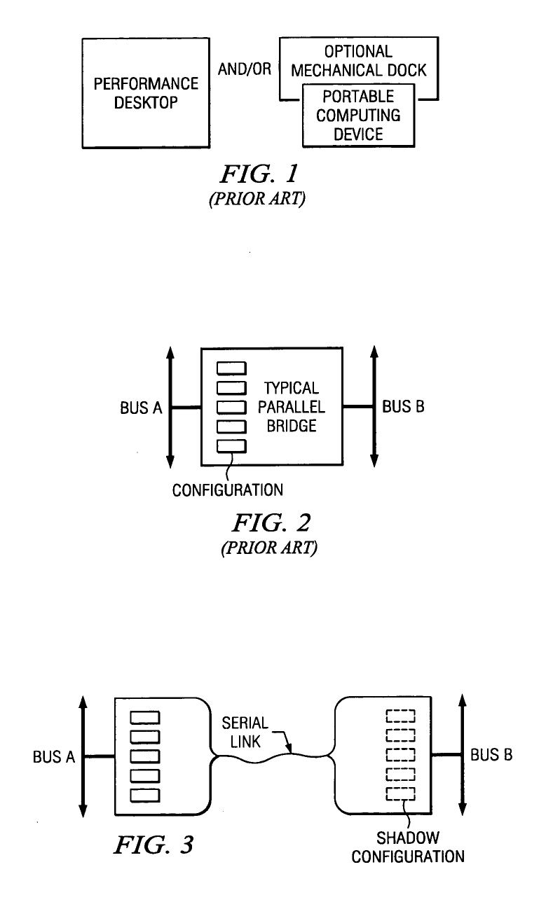

### DETAILED DESCRIPTION OF THE PREFERRED EMBODIMENT

Referring to FIG. 3, there is depicted the proprietary Split-Bridge™ technology serial communications technology of the present applicant, discussed in great detail in commonly assigned U.S. patent application Ser. No. 09/130,057 filed Jun. 6, 1998, and Ser. No. 09/130,058 also filed Jun. 6, 1998 the teachings of which are incorporated herein by reference.

Applicant Split-Bridge™ technology revolutionizes the status quo for computer systems. The Split-Bridge™ technology does not require the need for custom hardware or custom software to achieve full performance serial communication between devices, including devices having parallel data buses including the PCI bus. In fact, for each device in a modular computer system, the Split-Bridge™ technology appears just like a standard PCI bridge, and all software operating systems and device drivers already take such standard devices into consideration. By utilizing standard buses within each device operating within the modular computer system, each device does not require any additional support from the Operating System (OS) software. The modular computing system has simple elegance, allowing the PCI bus which is so pervasive in the computer industry, that possible applications of the initial PCI form of Split-Bridge ™ technology are all most limitless.

Originally implemented in PCI, there is nothing fundamental that ties the Split-Bridge™ technology to PCI, and thus, the Split-Bridge™ technology can migrate as bus architectures grow and migrate. The 64 bit PCI is compatible with the Split-Bridge™ technology, as is future PCIx and/or LDT or other bus technologies that are currently under consideration in the industry and which are straight forward transitions of the Split-Bridge™ technology. Implementations with other protocols or other possible and natural evolutions of the Split-Bridge™ technology, including digital video (DV) technology that can be streamed over the high-speed serial link.

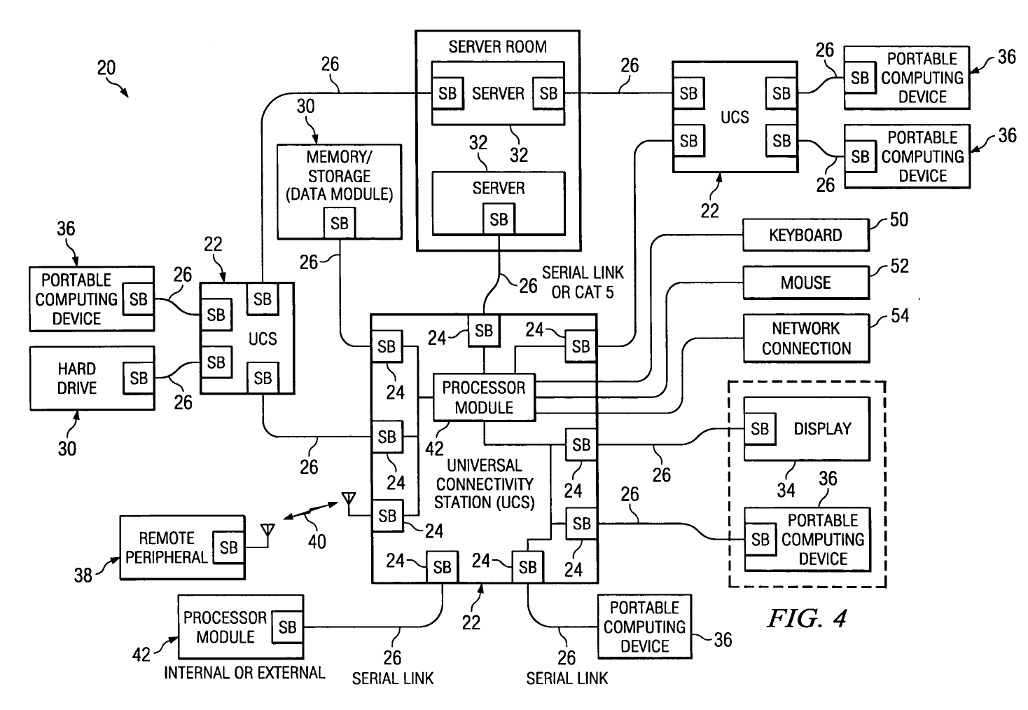

Referring to FIG. 4, there is depicted at 20 a modular computer system according to one illustrative embodiment of the present invention. The modular computer system 20 is based around one or more universal connectivity stations generally shown at 22 each having a plurality of interface ports 24 which are preferably based on the proprietary Split-Bridge™ technology of the present applicant, Mobility Electronics of Phoenix Ariz. Each UCS 22 provides input/output, or I/O, capability of the computer or computer system 20, as well as modular expansion capability and features. UCS 22 includes all possible variations and combinations of port replication and connectivity, including but not limited to the following ports: P/S2, mouse and keyboard, serial, parallel, audio, USB, IEEE 1394, or firewire, SCSI, and the like. Each UCS 22 also includes the ability to expand the capability or features of the computer system 20 by adding any type of drive bays, including EIDE, USB, and 1394 CD Roms, DVD's, hard drives, tape back up's, ZIP drives®, Jazz® drives, and the like.

A plurality of interconnecting and interactive devices are communicably coupled to each UCS 22 via respective high speed serial links generally shown at 26 based on the proprietary Split-Bridge™ technology. In the hardwire embodiment, the serial links 26 comprise of a pair of simplex links forms a duplex link interconnecting each end of the Split-Bridge™ technology interfaces as shown. The serial links 26 may also employ optical fiber and optical transceivers if desired. The various modules making up modular computer system 20 may include, and a plurality of, but are not limited to, a memory/storage device 30, servers 32 having one or multiple processors and possibly serving other UCS's 22, as shown, and modular computer systems, remote users and so forth, a display 34, a portable computing device 36, such as a notebook computer, a laptop computer, a portable digital assistant (PDA), and a remote wireless peripheral 38 which may interconnected via a wireless link shown at 40 and implementing the proprietary Split-Bridge™ technology. Examples of remote wireless terminals 38 may include 3^{rd} generation (3G) devices now being developed and employed, including wireless personal devices having capabilities for voice, data, video and other forms of information which can be unidirectionally or bidirectionally streamed between the remote peripheral 38 and UCS 22. An appropriate antenna resides at each of the remote peripheral 38 and UCS 22 which are interconnected to respective transceivers communicably coupled to the respective ends of the Split-Bridge™ technology interfaces.

Moreover, multiple UCSs 22 can be integrated to communicate with each other via serially links 26, each UCS 22 locally serving multiple modules. Multiple computers can be connected to a common UCS, or to multiple UCS's. For example, a computer or server room can have rack's of computer processors or servers, each separately connected over a system of up to hundred's of feet, to one or many UCS's located throughout an office or other environment. This allows the desktop to have just a terminal or whatever capabilities the IT manager desires, enhancing security and control.

System 20 also provides the ability to simultaneously connect multiple computers 36 and allows full peer-to-peer communications, allowing the processor module (CPU) 42 to communicate with the portable device computer 36 or to the computer room computers 32, allowing all of these computers to share information and processing capability. This also allows certain of the computers, such as the portable computer 36, to upgrade its processing capability when it is connected to the UCS 22 with other higher capability computers.

Still referring to FIG. 4, the modular computer system 20 of the present invention further comprises a processor module 42, which may be remotely positioned from the UCS 22, but for purposes of inclusion, could internally reside with the UCS 22. The processor module 42, from a performance point of view, is the heart and sole of the modular computer system 20 and can be made up of one or more core parts including: the CPU, memory, AGP Graphics, and a system bus interface to connect the other 3 together. The processor module 42 operates in conjunction with memory such as a hard disk drive, which can reside within the processor module 42, or be remotely located as shown at 30 if desired. The AGP Graphics could be located separately within the system and interconnected via a serial link 26, or even located within UCS 22 if desired.

Advantageously, the processor module 42 which may comprise of a high speed microprocessor or microprocessors, digital signal processors (DSP's), and can be upgraded or interchanged from the systems 20 without effecting the other devices or operation of the system, thereby permitting increased performance at a very low cost. Computers today typically require the replacement or upgrading of other devices when the performance portion of the computer system is replaced. The modular computer system 20 of the present invention revolutionizes the computer architectures available by separating out the processor module 42 from the rest of the computer system 20. Each of the modules 30, 32, 34, 36, and 38 all have functional access and use of the processor module 42 via the UCS 22 over the respective serial links 26 and 40, and from a performance point of view, appear to each of these devices to be hardwired to the processor module 42. That is, the Split-Bridge™ technology links interconnecting each of the devices via the UCS 22 to the processor module 42 is transparent to each device, thus requiring no change to the OS of each device, the format of data transfer therebetween, or any other changes. This is rendered possible by the revolutionary Split-Bridge™ technology.

Another advantage of computer system 20 is that the data module 30 may be customized, portable, and used only by one user. This allows the user to take the portable module 30 with them from location to location, system 20 to system 20. The data module 30 can store each users unique information, and can be accessed and used on any processor module 42 and UCS 22.

As discussed in considerable detail in the cross-referenced and commonly assigned patent applications, the Split-Bridge™ technology provides that information from the parallel buses of each device be first loaded into first-in first-out (FIFO) registers before being serialized into frames for transmission over the high speed serial link. Received frames are deserialized and loaded into FIFO registers at the other end thereof, such as UCS 22, for being placed onto the destination bus of the opposing device. Interrupts, error signals and status signals are sent along the serial link. Briefly, the proprietary Split-Bridge™ technology takes address and data from a bus, one transaction at a time, together with 4 bits that act either as control or byte enable signals. Two or more additional bits may be added to tag each transaction as either an addressing cycle, an acknowledging of a non-posted write, a data burst, end of data burst or cycle. If these transactions are posted writes they can be rapidly stored in a FIFO register before being encoded into a number of frames that are sent serially over the link. When pre-fetched reads are allowed, the FIFO register can store pre-fetched data in case the initiator requests it. For single cycle writes or other transactions that must await a response, the bridge can immediately signal the initiator to retry the request, even before the request is passed to the target.

In the preferred embodiment of the modular computer system of the present invention, one or more of the busses in the plurality of devices, as well as in the UCS 22, employ the PCI or PCMCIA standard, although it is contemplated that other bus standards can be used as well. The preferred Split-Bridges™ technology operate with a plurality of configuration registers that is loaded with information specified under the PCI standard. The Split-Bridges™ technology transfer information between busses depending on whether the pending address falls within a range embraced by the configuration registers. This scheme works with devices on the other side of the Split-Bridge™ technology, which can be given unique base addresses two avoid addressing conflicts.

As disclosed in great detail in the co-pending and cross-referenced commonly assigned patent applications, the Split-Bridges™ technology may be formed as two separate application-specific integrated circuits (ASICs) joined by a duplex link formed as a pair of simplex links. Preferably, these two integrated ASICs have the same structure, but can act in two different modes in response to a control signal applied to one of its pins. Working with hierarchical busses (primary and secondary busses) these integrated circuits are placed in a mode appropriate for its associated bus. The ASIC associated with the secondary bus preferably has an arbitrator that can grant masters control of the secondary bus. The ASIC can also supply a number of ports to support other devices such as a USB and generic configurable I/O ports, as well as parallel and serial ports.

The UCS preferably comprises a PCI bus having a plurality of PC card slots located with the UCS housing. Each PC card slot is provided with a Split-Bridge™ technology interface, and preferably one of the ASICs assembled with a standardized serial connector comprising at least 4 pins, as depicted in the cross referenced commonly assigned patent applications, the teachings of which are incorporated herein by reference.

The modular computer system 20 of the present invention derives technical advantages in that the UCS station 22 with its associated interface cards and parallel data bus interconnecting each interface card, is truly functionally transparent to each of the interconnected modules including the memory storage device 30, the server 32, the display 34, the portable computing device 36, the remote wireless peripheral 38, and the processor module 42. This integration of devices into a modular computer system has truly enormous potential and uses depending on the desired needs and requirements of one's computing system. However, the physical location and proximity of each of the devices forming the modular computer system are no longer strictly limited due to the high speed serial interconnection links of the proprietary Split-Bridge™ technology. Each of the devices can be remotely located, or located in proximity to one another as desired. For instance, the display 34 and portable computing device 36 may be resident within one's office, with the UCS 22 in another room, and with the memory storage device 30, server 32, and performance module 42 remotely located in yet still another room or location. Moreover, a plurality of portable computing devices 36 can all be remotely located from UCS 22, and from each other, allowing networking to modular system 20 either through wireless serial links as depicted at 26, or wirelessly as depicted at 40.

The proprietary Split-Bridge™ technology presently allows for extended communication distances of 5 meters, but through advancement in technology can continue to be extended. For instance, using optical communication links in place of copper wire simplex links, along with suitable optical transceivers, can yield links that are exceptionally long. Using wireless technology, as depicted at 40, allows a remote peripheral 38 to be located perhaps anywhere in the world, such as by implementing repeaters incorporating the proprietary Split-bridge™ technology high speed serial communication technology. Additional techniques can be used by slowing the transfer rate, and increasing the number of pipes, to achieve link distances of hundreds of feet, and allowing the use of CAT5 cable.

Still referring to FIG. 4, there is shown that UCS 22 provides communication between portable computing device 36 and display 34. As previously mentioned, portable computing device 36 may include a notebook computer, a laptop computer, and a portable digital assistant (PDA), for instance. UCS 22 also provides communication between a remote peripheral 38 and display 34, as shown, whereby the remote peripheral 38 maybe interconnected via a wireless link shown at 40. As previously mentioned, examples of remote wireless terminals 38 may include 3^{rd} generation (3G) devices including wireless personal devices having capabilities for voice, data, video and other forms of information which can be unidirectionally or bidirectionally streamed between the remote peripheral 38 and UCS 22. Today, with the versatility of PDA's currently available, the UCS 22 advantageously provides communications between PDA's 36 and remote peripherals 38 to other physically remote devices, including display 34.

One technical advantage of the present invention is portable computing device 36 driving data to display 34 for the visual rendition thereof. A well known visual presentation application, known as PowerPoint® and manufactured by Microsoft, is ideally suited for use with the modular system 20 of the present invention. Advantageously, a PowerPoint® application running on PDA 36 or wireless peripheral 38, such as a Smartphone, can be remotely displayed on display 34. The modular system of the present invention provides a universal platform enabling many different physically remote portable devices 36 and 38 to communicate with other physically remote devices, such as display 34. For example, PowerPoint® presentations maybe created by a user on a PC, and transferred to PDA 36, allowing a user to give PowerPoint® presentations using the PDA 36 in a presentation mode. Of course, other visual presentations may be provided using PDA 36 and displayed on display 34, such as for training, demonstrations, sales presentations, and so forth.

As further shown in FIG. 4, UCS 22 is further configured to receive input data from input devices, such as keyboard 50 and a mouse 52. Processor module 42, which can either be internal or external to UCS 22, is adapted to translate and configure keyboard and mouse input data for communication to portable computing device 36. For instance, processor module 42 may configure keyboard 50 inputs as keystrokes, and mouse movements and clicks into a visual cursor for display on the portable computing device 36 and clicks to simulate stylus taps.

Although many operating systems are operable on processor module 42, one preferred operating system is Linux, created by IBM Corporation, because it is free, and has fast support for the features of the present invention.

In one preferred embodiment, the portable computing device 36 is a PDA which may have an operating system that is different or common to that operating on processor module 42. For instance, some PDA's currently operate on the Palm OS, as well as PocketPC and Symbian.

PDA 36 is operable to execute a PowerPoint® presentation, and allows a user to view the presentation on the PDA, and download the presentation to the UCS 22 and render the presentation on display 34. In one embodiment, processor 42 executes the downloaded presentation from display 36, drives the visual output to display 34, and is responsive to the PDA 36 which may operate as a presentation controller once the presentation has started. In addition, the presentation executing on processor 42 also may be controlled in response to control input received from keyboard 50 and mouse 52. Processor 42 converts the inputs from keyboard 50 and mouse 52, formats the data, and inserts the translated data into a data queue and sends this formatted data queue to PDA 36. PDA 36 receives and responds to this translated keyboard and mouse data such that keyboard inputs are recognized as key strokes, and the mouse motion and click data is visually rendered as a cursor, and the mouse clicks are processed by the PDA as stylus taps.

More detailed information on the individual components of one preferred embodiment visually rendering a PowerPoint® presentation stored at portable computing device 36 to a physically remote display 34 will now be provided, including the PC utility which may create a PowerPoint® presentation, a PDA presentation utility, a PDA remote display utility, the UCS firmware, USB host functionality, PDA infrared functionality, PDA background thread, and PDA keyboard and mouse functionality.

PC Utility Details:

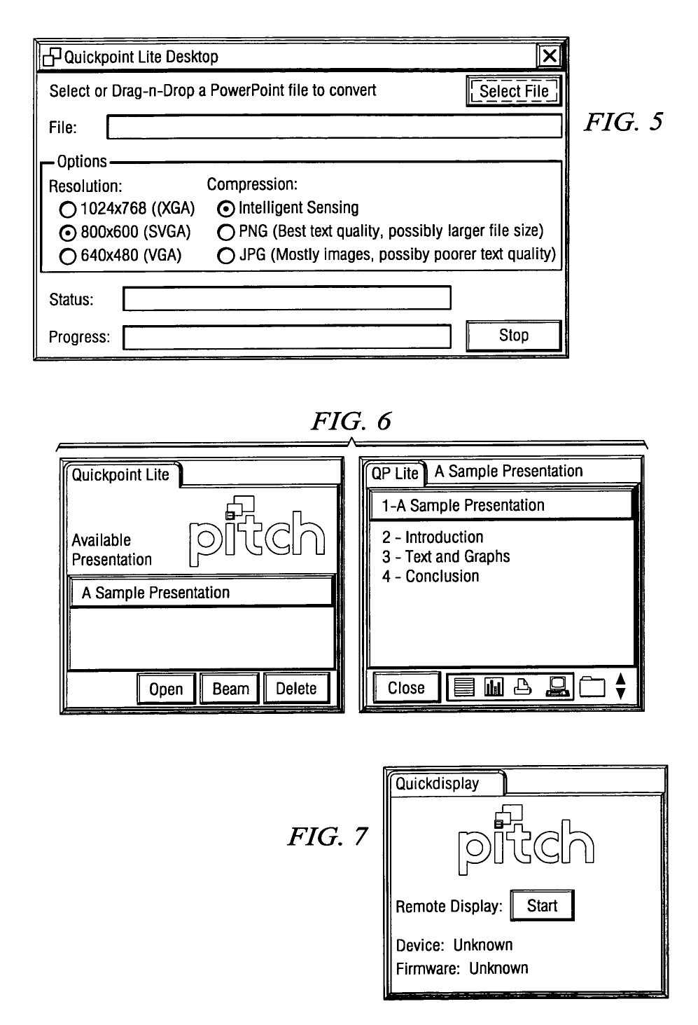

The PC Utility is designed as a stand-alone Windows application. It allows the user to browse for a PowerPoint® file (or drag-n-drop if desired). Once the PowerPoint® file is selected, it is converted into a series of JPG or PNG images (this is standard functionality of Microsoft PowerPoint®). These series of images are stored into a file with a proprietary format that is usable on the PDA. The proprietary format is based on the PalmOS database specification, with each image broken up to fit into 32 KByte records. The last record of the database is a string table that stores all of the text associated with the presentation. (Jason, How?) Besides storing the images, the file also stores some basic information about the presentation. Once a presentation is converted into PDA file format, it is installed to the PDA using standard methods as provided by the PDA vendor. A displayed window of the PC utility is shown in FIG. 5.

PDA Presentation Utility:

The PDA Presentation utility runs on the PDA 36 and initially scans the PDA 36 and provides a listing of all available presentations, as shown in FIG. 6. The user can select a single presentation, which then provides a listing of all slides in the presentation. The user can select a single slide and view its image, text or notes on the PDA screen. When the user selects to start a presentation, the images are downloaded to the UCS device 22. The user can then change the currently displayed image on the UCS device 22 by selecting the desired slide from the list on the PDA 36. The user can select to go into IR (infrared) mode and then use the PDA 36 to switch slides while disconnected. The infrared commands are implemented using a scheme in conjunction with standard consumer IR technology (as is used in TV remote controls), as discussed below. While a presentation is active (has been started), keyboard and mouse commands from keyboard 50 and mouse 52 can be received by the PDA 36 from the UCS device 22. These commands are parsed and checked to see if the user wants to move forward or back in the slide order.

PDA Remote Display Utility:

The PDA Remote Display (RD) utility runs on the PDA 36 and allows the user to send the current PDA display to be displayed by the UCS device 52. When the user selects to start the remote display, the RD utility puts the UCS device 22 into the correct mode, downloads and displays the background skin image (usually a picture of the PDA device), as shown in FIG. 7, and then starts a background thread. The background thread uses standard system calls to find the current size and resolution of the PDA 36 display, which is then sent to the UCS device 22. The background thread then uses standard system calls to continually get the PDA display image and send it to the UCS device 22. The background thread also checks for keyboard and mouse commands to be received from the UCS device 22. Keyboard commands are inserted into the standard PDA input queue, simulating the input of a keystroke. Mouse commands are inserted into the standard PDA input queue, simulating stylus taps and movements, as shown in the following API specification.

Pitch Firmware:

The UCS 22 Linux system consists of several different software components. These are the boot loader, the Linux kernel, the file system and the UCS 22 application.

The boot loader is a component that loads the Linux kernel and file system from flash memory into RAM memory. Special initialization for our specific system as well as added the ability to load from flash memory that was larger than 1 Megabyte. (Jason, discuss if necessary, or we will delete if not). Probably delete since there is nothing necessarily novel about loading flash memory larger than 1 Megabyte, it was just different than the implementation that we started with.

The Linux kernel is the base operating system that makes the UCS device 22 function. It is obtainable from a kernel.org standard download. The kernel is modified in several different ways to optimize it for the present invention and to achieve performance improvements. These improvements consist of removed unnecessary code in the chip initialization, USB PDA driver performance enhancements, and USB PDA specific device identifier additions.

The file system contains all the programs necessary for the Linux system to operate and perform tasks. The correct programs are located in the correct locations so that the Linux system and the UCS 22 application get up and running properly.

The UCS 22 application is the program that starts after the Linux kernel gets booted and provides the interface for communicating with the PDA device 36. This application is based on the attached API specification. This application waits for PDA device 36 to connect in to the UCS device 22. When a PDA device 36 connects, this application starts receiving data from the PDA device 36. All received data is parsed to look for commands. When a command is recognized, it is executed appropriately. While a PDA device 36 is connected, the application detects any keyboard or mouse activity. If any keyboard activity is detected, the keystroke is sent in a command to the PDA 36. If any mouse activity is detected, the cursor is made visible on the PDA 36. If the mouse activity is a click up or down or movement while click down, then the activity is sent in a command to the PDA 36. While a PDA device 36 is not connected, the application detects any IR activity and parses it for any commands. If a command is recognized, it is executed appropriately.

USB Host Functionality

The USB Host functionality was created because the USB functionality of the Palm and PocketPC devices 36 was undocumented. Communication channels in USB occur over device endpoints. The Linux USB host system executing on UCS 22 provides a communication channel to every endpoint that is exposed by the USB device. Some Palm devices 36 expose more than one input endpoint and/or more than one output endpoint. Advantageously, the UCS 22 application connects to the highest numbered endpoint to allow operability with more than one endpoint. On a Palm device 36, it was discovered that there is always a communications port called ‘usbd’. This port is opened using the SrmOpen system call, allowing the Palm 36 to begin communicating over USB. On a PocketPC device 36, it was discovered that the USB communication port can vary from device to device. However, the USB port name is always stored in the registry with a name that has ‘USB’ in it. UCS 22 scans the registry on the PocketPC 36 and finds the port name with ‘USB’, opens the port using the CreateFile system call, and begins communicating over USB.

USB communication on a host system is encompassed in USB Request Blocks (URBs). Unfortunately, a typical Linux implementation only provides for a single URB to be issued at a given time to each USB device. This means that a request is placed out in a URB and then returned once the device responds. The URB must be processed and then a new request is placed out in the URB. This is limiting on performance since data is not being transferred while the URB is being processed by the host system. The performance of the USB host system is improved in the present invention by adding many (32) additional URBs so that the USB achieves its full potential.

PDA Infrared Functionality

There are two common forms of infrared (IR) communications. One form is IRDA which is commonly used for computer communications (PCs, Palms, etc), and another is Consumer IR which is commonly used for remote controls. The Consumer IR is preferred since its range is much better than IRDA. Consumer IR works by sending varying length pulses of a carrier signal. The present invention uses a 38 KHz carrier signal receiver since the UCS 22 uses standard baud rates on PDA 36. The problem is that standard Palm devices 36 only support IRDA mode.

In order to get Consumer IR signals from the Palm devices, the IR port is opened using the SrmOpen system call and then the port is changed into the IR mode with a baud of 115200, 7 data bits, 1 stop bit and no parity using the SrmControl system call. Data is then sent by sending a stream of 0×5B bytes to simulate a carrier signal. A long carrier signal of 30 bytes represents a zero and a short carrier signal of 5 bytes represents a one.

In order to get Consumer IR signals from the PocketPC devices 36, the IR port is opened is opened using the CreateFile system call and then the port is changed into the IR mode using the EscapeCommFunction system call. The correct settings of baud 38400, 8 data bits, 1 stop bit and no parity are set using the SetCommState system call. Data is then sent by sending a stream of 0×00 bytes to simulate a carrier signal. A long carrier signal of 10 bytes represents a zero and a short carrier signal of 2 bytes represents a one.

PDA Background Thread Functionality

The PalmOS operating system is not designed for user applications to have background threads. The remote display application requires that it run in the background so that other applications can run and be displayed. For PalmOS versions before 5, a thread is created by:

Allocating a stack using the MemChunkNew and MemPtrSetOwner system calls

Create the thread by using the SysTaskCreate system call

Setup the termination procedure by using the SysTaskSetTermProc system call

Start the thread by using the SysTaskTrigger system call

The thread can later be stopped by calling the SysTaskDelete system call For PalmOS versions after 5, a thread is created by:

Launching the application again using the SysAppLaunch system call

Create a sound stream thread using the SndStreamCreate system call

Start the sound stream thread using the SndStreamStart system call

The thread can later be stopped by calling the SndStreamDelete system call

The PocketPC 36 operating system is designed for background threads. A thread is started using the standard system call CreateThread.

PDA Keyboard and Mouse Functionality

When running the remote display mode, the keyboard and mouse events are translated by processor 42 into keystrokes and stylus taps and movements. When the UCS device 36 detects keyboard or mouse events, they are formatted according to the UCS API and sent to the PDA 36. For PalmOS, keystrokes are inserted into an event queue using the EvtEnqueueKey system call. Stylus taps and movements are inserted into the event queue using the PenScreenToRaw and EvtEnqueuePenPoint system calls. For a PocketPC 36, keystrokes and stylus taps and movements are all inserted into the event queue using the SendInput system call. For Symbian OS, keystrokes are inserted into the event queue using the TApaTask::SendKey system call. Stylus taps and movements are inserted into the event queue using the RWsSession::SimulateRawEvent system call.

| Version | Date | Notes |
|---|---|---|
| 0.1 | Aug. 16, 2001 | Initial draft |
| (draft) | | |
| 0.2 | Sep. 27, 2001 | Added clear display in Display |
| | | Image command, added Query |
| | | Presentation Data command, added |
| | | Stop Presentation command |
| 0.3 | Oct. 03, 2001 | Added version fields to Set |
| | | Presentation & Query Presentation |
| | | commands and changed all version |
| | | fields to start at 0 instead of 1 |
| 0.4 | Jan. 14, 2002 | Added firmware download |
| | | command |
| 0.5 | Feb. 27, 2002 | Added Palm Display Emulation functionality |
| 0.6 | May 7, 2002 | Added Prepare Image functionality |
| 0.7 | Jun. 4, 2002 | Added Delete Image functionality |
| 1.1 | Sep. 23, 2002 | Added IR capabilities |
| 1.2 | Sep. 30, 2002 | Added autorun capabilities |
| 1.3.1 | Feb. 11, 2003 | Added native PPT capabilities and relative |
| | | mouse movements |

Overview:

This document describes the interface to send and display presentations to the UCS 22. The designed operation is for the presentation to be setup, images to be downloaded and then images to be displayed. The interface is designed to be used generically over any data link.

General Packet Structure:

Presentation data and commands are sent to the UCS 22 with a header that verifies the validity of the data and also describes the data to follow. The header is described as follows:

| Field | Size | Notes |
|---|---|---|
| Signature | 4 | “UCS” - identifies this as UCS data |

| | | | |
|---|---|---|---|
| Command | 2 | Command to perform: | |
| | | Query Presentation Hardware: | 0x0001 |
| | | Set Presentation Data: | 0x0002 |
| | | Set Image: | 0x0003 |
| | | Display Image: | 0x0004 |
| | | Stop Presentation: | 0x0005 |
| | | Query Presentation Data: | 0x0006 |
| | | Prepare Image: | 0x0007 |
| | | Delete Image: | 0x0008 |
| | | Autorun: | 0x0009 |
| | | Set Emulate Mode Data: | 0x0010 |
| | | Emulate Mode Blt: | 0x0011 |
| | | Keyboard Data: | 0x0012 |
| | | Mouse Data: | 0x0013 |
| | | Firmware Download Header: | 0x1000 |
| | | Return Status: | 0x8000 |

| | | |
|---|---|---|
| Data Size | 4 | Number of bytes of command specific |
| | | data to follow |

NOTE:
All data fields are represented with network (non-swapped) byte ordering. (e.g. the first command would appear as 0x0001 - NOT 0x0100).

Return Status Structure:

This command allows other commands to be acknowledged with success or failure.

| Field | Size | Notes | |
|---|---|---|---|
| Signature | 4 | | |
| Command | 2 | Command = 0x8000 | |
| Data Size | 4 | Size = 4 + n (if any additional bytes are | |
| | | required for the response) | |
| Command | 2 | The command for which this return command | |
| Being | | is being sent | |
| Acknowledged | | | |
| Status | 2 | The completion status of the request: | |
| | | Success: | 0x0000 |
| | | Not supported: | 0x0001 |
| | | General failure: | 0x0002 |
| | | Insufficient resources: | 0x0003 |
| | | CRC error: | 0x0004 |
| | | Programming error: | 0x0005 |
| | | Erase error: | 0x0006 |
| | | Verify error: | 0x0007 |

| | | |
|---|---|---|
| Return Data | 0..n | Return data is only sent for commands that |
| | | require return data |

Query Presentation Hardware:

This command allows presentation software to query the hardware to determine compatibility.

| Field | Size | Notes |
|---|---|---|
| Signature | 4 | |
| Command | 2 | Command = 0x0001 |
| Data Size | 4 | Size = 0 |

The return response is described as follows:

| Field | Size | Notes |
|---|---|---|
| Signature | 4 | |
| Command | 2 | Command = 0x8000 |
| Data Size | 4 | 4 + 14 = 18 |
| Command | 2 | 0x0001 (for the Query Hardware command) |
| Being | | |
| Acknowledged | | |
| Status | 2 | |
| Version | 2 | The version of the structure of the data to |
| | | follow, currently just = 0. Presentation software |
| | | will key off of this value to determine if they |
| | | know how to communicate with the hardware. |
| Model | 2 | Model number of the hardware device |
| Model | 2 | Revision number of the model (0 for the first rev, |
| Revision | | incrementing if newer revs are ever released) |
| Firmware | 4 | Version information of the firmware. |
| Version | | |
| Capabilities | 4 | Capabilities of the hardware. Bit 0 = JPEG image, |
| | | Bit 1 = PNG |
| | | image, Bit 2 = Palm Display Emulation, Bit 3 = |
| | | IR remote, Bit |
| | | 4 = Native PPT, Bit 5 = Native PPT download, |
| | | Bit 6 = Accepts |
| | | Keyboard & Mouse. Presentation software will |
| | | check this value to determine what type of data |
| | | can be sent. |

Set Presentation Data:

This command configures the settings to setup the presentation. It also resets the previous presentation data and images. This command should be sent at the start of every presentation.

| Field | Size | Notes |
|---|---|---|
| Signature | 4 | |
| Command | 2 | Command = 0x0002 |
| Data Size | 4 | Size = 12 (version 0), 8 + n (version 1) |
| Version | 2 | The version of the structure of the data to follow, |
| | | 0 and 1 are supported. UCS will key off of this |
| | | value to determine the format of the data to follow. |
| ID | 4 | Unique presentation ID (only in version 0) |
| Display | 2 | Number of pixels of screen width (max = 1024, |
| Width | | min = 640) |
| Display | 2 | Number of pixels of screen height (max = 768, |
| Height | | min = 480) |
| Color Depth | 1 | Number of bits per pixel (8, 24) |
| Scan | 1 | Value in Hertz (usually somewhere in the 60-85 |
| Frequency | | range, 60 is a good default) |
| Name | 2..n | Name of the presentation in the file system (only in |
| | | version 1) |

Set Image:

This command sets an image to be used in the presentation.

| Field | Size | Notes |
|---|---|---|
| Signature | 4 | |
| Command | 2 | Command = 0x0003 |
| Data Size | 4 | Size = 6 + image size (number of bytes in the |
| | | image) |
| Image ID | 4 | Unique identifier for this image, specified by the |
| | | controlling device (the Palm app). Does not need to |
| | | be sequential with other images. Cannot be 0. |
| Image Type | 2 | Type of image that follows: |
| | | JPEG: 0x0001 |
| | | PNG: 0x0002 |
| Image Data | n | Image data |

Display Image:

This command displays an image on the screen. The image is displayed by first drawing the specified background image and then drawing the image. Note that JPEG does not support transparency, so drawing a JPEG on top of any other image will hide that image.

| Field | Size | Notes |
|---|---|---|
| Signature | 4 | |
| Command | 2 | Command = 0x0004 |
| Data Size | 4 | Size = 12 |
| Image ID | 4 | Identifier for the image to display. Cannot be 0 for |
| | | a valid image. |
| Background | 4 | Identifier for the background image to display. 0 |
| | | specifies no |
| ID | | background. −1 specifies clear display. For Native |
| | | PPT 0 specifies Image ID is an ID, 1 specifies |
| | | Image ID is the slide number(index + 1) |
| Horizontal | 2 | Horizontal offset to begin drawing the image. |
| Offset | | This allows smaller (smaller than the full |
| | | screen) images to be drawn within the display. |
| | | Ignored for Native PPT. |
| Vertical | 2 | Vertical offset to begin drawing the image. Ignored |
| Offset | | for Native PPT. |

Prepare Image:

This command prepares an image to be displayed, performing necessary decompression and setup. Only one image can be prepared. When this command is issued, the previously prepared image is overwritten.

| Field | Size | Notes |
|---|---|---|
| Signature | 4 | |
| Command | 2 | Command = 0x0007 |
| Data Size | 4 | Size = 8 |
| Image ID | 4 | Unique identifier for the image to prepare. |
| Background | 4 | Identifier for the background image when using |
| | | transparency. 0 |
| ID | | specifies no background. −1 specifies clear |
| | | background. |

Delete Image:

This command deletes an image (or all images) from the device.

| Field | Size | Notes |
|---|---|---|
| Signature | 4 | |
| Command | 2 | Command = 0x0008 |
| Data Size | 4 | Size = 4 |
| Image ID | 4 | Unique identifier for the image to delete. 0 specifies |
| | | delete all images. |

Stop Presentation:

This command allows presentation software to stop the presentation (which allows the presentation hardware to stop driving the display and go into a lower power mode).

| Field | Size | Notes |
|---|---|---|
| Signature | 4 | |
| Command | 2 | Command = 0x0005 |
| Data Size | 4 | Size = 0 |

Query Presentation Data:

This command allows presentation software to query which presentation is currently loaded.

| Field | Size | Notes |
|---|---|---|
| Signature | 4 | |
| Command | 2 | Command = 0x0006 |
| Data Size | 4 | Size = 0 |

The return response is described as follows:

| Field | Size | Notes |
|---|---|---|
| Signature | 4 | |
| Command | 2 | Command = 0x8000 |
| Data Size | 4 | 4 + 8 = 12 (version 0), 4 + 4 + n (version 1) |
| Command | 2 | 0x0006 (for the Query Presentation Data |
| Being | | command) |
| Acknowledged | | |
| Status | 2 | |
| Version | 2 | The version of the structure of the data to |
| | | follow, 0 and 1 are supported. Presentation |
| | | software will key off of this value to |
| | | determine the format of the data to follow. |
| ID | 4 | Unique presentation ID (only in version 0) |
| Number of | 2 | Number of images that have been downloaded |
| Images | | for this presentation |
| Name | 2..n | Name of the presentation (only in version 1) |

Autorun Presentation:

This command sets the presentation to switch slides automatically.

| Field | Size | Notes |
|---|---|---|
| Signature | 4 | |
| Command | 2 | Command = 0x0009 |
| Data Size | 4 | Size = 2 |
| Delay | 2 | Time delay between slides (in seconds). |

Set Emulate Mode Data:

This command configures the settings to setup for emulating another format of display within the current display format. This is useful when displaying the contents of the Palm Display. This can only be set when the overall mode is set for 24-bit color depth.

| Field | Size | Notes |
|---|---|---|
| Signature | 4 | |
| Command | 2 | Command = 0x0010 |
| Data Size | 4 | Size = 4 + palette_size |
| Version | 2 | The version of the structure of the data to |
| | | follow, currently just = 0. PSPD will key off of |
| | | this value to determine the format of the data to |
| | | follow. |
| Color Depth | 1 | Number of bits per pixel (1, 2, 4, 8) |
| Stretch | 1 | Multiply factor to increase the size of the pixels |
| Factor | | that are sent in emulation mode. |
| Palette | 2\hat{ }bpp*4 | Palette entries (the number depends on the |
| | | color depth): 1:2, 2:4, 4:16, 8:256. |

Emulate Mode Blt:

This command sends pixels that should be blitted to the screen using the current emulation mode.

| Field | Size | Notes |
|---|---|---|
| Signature | 4 | |
| Command | 2 | Command = 0x0011 |
| Data Size | 4 | Size = 8 + image size (number of bytes in |
| | | the image) |
| X offset | 2 | X offset to begin the draw. |
| Y offset | 2 | Y offset to begin the draw. |
| Width | 2 | Width (in pixels) of the image |
| Height | 2 | Height (in pixels) of the image |
| Image Data | n | Image data |

Keyboard Data:

This command gives keystroke data. Will only have a return packet if it causes an event. Return data will be another command.

| Field | Size | Notes |
|---|---|---|
| Signature | 4 | |
| Command | 2 | Command = 0x0012 |
| Data Size | 4 | Size = number of keyboard characters |
| Data | N | Keyboard data. Ascii char, 0x80 + # = special char, |
| | | 0x81 + char = shift char, 0x82 + char = |
| | | control char, 0x83 + char = alt char. |

Mouse Data:

This command gives mouse event data. Will only have a return packet if it causes an event. Return data will be another command.

| Field | Size | Notes |
|---|---|---|
| Signature | 4 | |
| Command | 2 | Command = 0x0013 |
| Data Size | 4 | Size = 6 |
| X location | 2 | X location of the event |
| Y location | 2 | Y location of the event |
| Command | 2 | Command to process. 1=abs move, 2=abs |
| | | left down, 3=abs left up, 4=abs right down, |
| | | 5=abs right up, 6=rel move, 7=rel left |
| | | down, 8=rel left up, 9=rel right down, |
| | | 10=rel right up |

Firmware Download:

This command sends a firmware image to program into the flash on the device.

| Field | Size | Notes |
|---|---|---|
| Signature | 4 | |
| Command | 2 | Command = 0x1000 |
| Data Size | 4 | Size = 8 + firmware image size |
| Offset | 4 | The offset from the start of flash to write the |
| | | flash image. |
| CRC | 4 | CRC of the flash image. |
| Image Data | n | Firmware Image data |

The return response is described as follows:

| Field | Size | Notes |
|---|---|---|
| Signature | 4 | |
| Command | 2 | Command = 0x8000 |
| Data Size | 4 | 4 + 6 = 10 |
| Command | 2 | 0x1000 (for the Firmware Download |
| Being | | command) |
| Acknowledged | | |
| Status | 2 | |
| Stage being | 2 | 1 = received download file, 2 = programming |
| acknowledged | | progress, 3 = programming complete |
| Current | 4 | Address for location of programming progress |
| Address | | (2 with status OK) or programming error (3 |
| | | with status ERROR). |

Multiple responses will be sent after receiving the Firmware download command. Initially a response will be sent to acknowledge that the image was received properly and then multiple status responses will be sent as the flash is programmed. Finally, a status response will be sent to indicate that programming is complete.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

We claim:

1. A connectivity device, comprising:
a processor executing an operating system;
a first interface responsively coupled to the processor and adapted to communicate with a physically remote handheld portable communications device; and
a second interface responsive to the processor and adapted to drive a physically remote display as a function of commands received from the physically remote handheld portable communications device.

2. The connectivity device as specified in claim 1 wherein the operating system is configured as a USB host system providing a communication channel to the handheld portable communications device.

3. The connectivity device as specified in claim 2 wherein the operating system is configured to connect to a highest numbered endpoint via the first interface.

4. The connectivity device as specified in claim 1 wherein the handheld communications device comprises a PDA.

5. The connectivity device as specified in claim 1 wherein the handheld communications device comprises a smartphone.

6. The connectivity device as specified in claim 1 wherein the first interface is adapted to serially communicate with the handheld communications device.

7. The connectivity device as specified in claim 1 wherein the first interface is adapted to wirelessly communicate with the handheld communications device.

8. The connectivity device as specified in claim 1 wherein the handheld communications device has a processor, and memory storing data indicative of visual images, wherein the second interface is adapted to communicate the data to the display device for visually rendering the data.

9. The connectivity device as specified in claim 8 wherein the data is indicative of slides and forms a visual presentation.

10. The connectivity device as specified in claim 9 wherein the data is in a Powerpoint®(D format.

11. The connectivity device as specified in claim 1 further comprising a third interface adapted to receive control data and responsively communicate the control data to the handheld communications device.

12. The connectivity device as specified in claim 11 wherein the third interface is adapted to receive and communicate the control data from a keyboard.

13. The connectivity device as specified in claim 12 wherein the third interface is adapted to receive and communicate the control data from a mouse.

14. The connectivity device as specified in claim 13 wherein the communication device is adapted to detect and forward the keyboard and mouse control data to the handheld communications device such that it is executable thereby.

15. The connectivity device as specified in claim 14 wherein the keyboard control data is translated into keystrokes such that it is executable by the handheld communications device.

16. The connectivity device as specified in claim 14 wherein the mouse control data is translated into stylus taps and cursor movements such that it is executable by the handheld communications device.

17. The connectivity device as specified in claim 15 wherein the keystrokes are inserted into a data queue.

18. The connectivity device as specified in claim 16 wherein the stylus taps and cursor movements are inserted into a data queue.

19. The connectivity device as specified in claim 13 wherein the connectivity device has a fourth interface adapted to receive wireless control data from a physically remote control device such that the connectivity device is controllable as a function of the wireless control data.

20. The connectivity device as specified in claim 8 wherein the first interface is adapted to communicate with the handheld communications device using a Bluetooth protocol.

21. The connectivity device as specified in claim 8 wherein the first interface is adapted to communicate with the handheld communications device using a 802.11 protocol.

22. The connectivity device as specified in claim 8 wherein the first interface comprises an infrared transceiver.

23. The connectivity device as specified in claim 1 wherein the operating system is based on a Linux Kernal.

24. The connectivity device as specified in claim 23 further comprising RAM memory operatively coupled to the processor.

25. A computer readable medium comprising instructions for:
receiving visual presentation data from a physically remote handheld computing device;
processing the visual presentation data; and
driving the processed visual presentation data to a physically remote display.

26. A computer readable medium as specified in claim 25 further comprising instructions for:
receiving keyboard and mouse input commands, translating the input commands, and transmitting the translated input commands to the handheld computing device; and
processing the visual presentation data as a function of the input commands.

27. A computer readable medium as specified in claim 26 wherein the handheld computing device is a PDA.

28. A computer readable medium as specified in claim 26 wherein the handheld computing device is a Smartphone.

29. A computer readable medium as specified in claim 26 further comprising instructions for wirelessly transmitting the translated input commands to the handheld computing device.

30. A computer readable medium as specified in claim 26 further comprising operating instructions for operating as a USB host system.

31. A computer readable medium as specified in claim 30 wherein the operating instructions are configured to connect to a highest numbered endpoint of the handheld computing device.

32. A computer readable medium as specified in claim 25 further comprising instructions for responding to wireless control commands and effecting driving of the processed presentation data to the physically remote display.

33. A computer readable medium as specified in claim 26 further comprising instructions for responding to wireless control commands and effecting transmission of data to the handheld computing device.

34. A computer readable medium as specified in claim 26 further comprising instructions for detecting and forwarding keyboard and mouse input commands to the handheld computing device.

35. A computer readable medium as specified in claim 34 further comprising instructions for translating the keyboard and mouse input commands to keystroke data, cursor movements and stylus tap data.

36. A computer readable medium as specified in claim 35 further comprising instructions for inserting the keystroke data, cursor movements and stylus tap data into a data queue executable by the handheld computing device.

37. A handheld computing device, comprising:
a display;
a processor adapted to execute a visual presentation program;
the processor further being adapted to receive and respond to control data received from a physically remote control device to control the visual presentation program.

38. A handheld computing device as specified in claim 37 wherein the processor is adapted to receive and respond to the control data being keystroke, cursor movement and stylus tap control data.

39. A handheld computing device as specified in claim 37 wherein the processor visual renders the keystroke and cursor movement data on the display in conjunction with the visual presentation program.

40. A handheld computing device as specified in claim 37 wherein the processor is adapted to run a PowerPoint® presentation.
